(19) United States
(12) Patent Application Publication
(10) Pub. No.: US 2020/0057161 A1
(43) Pub. Date: Feb. 20, 2020

(54) Obstacle sensing using lidar

(71) Applicant: BAE SYSTEMS Information and Electronic Systems Integration Inc., Nashua, NH (US)

(72) Inventors: Michael J. Choiniere, Merrimack, NH (US); Dimitre P. Dimitrov, Wayland, MA (US); Jason T. Whitwam, Billerica, MA (US)

(73) Assignee: BAE SYSTEMS Information and Electronic Systems Integration Inc., Nashua, NH (US)

(21) Appl. No.: 15/999,207

(22) Filed: Aug. 17, 2018

(51) Int. Cl. G01S 17/93; G01S 7/481; G01S 7/497; G06K 9/00

(52) U.S. Cl. CPC G01S 17/936; G01S 7/4817; G06K 9/00798; G06K 9/00805; G06K 9/00825; G01S 7/4972

(57) ABSTRACT

An obstacle sensing lidar system includes: a laser source to emit laser radiation in a horizontal fan-beam pattern of at least 60° at an angle of elevation in front of a moving platform; a sensing device having an array including a row of 100 or more near-infrared (NIR) sensors to sense corresponding reflections of the emitted laser radiation off obstacles in front of the moving platform, each NIR sensor being a pixel in the array; and elevation circuitry to adjust the angle of elevation of the emitted laser radiation to a first angle of elevation, a second angle of elevation greater than the first angle of elevation, and a third angle of elevation greater than the second angle of elevation. Sometimes, the first angle of elevation corresponds to the surface level, the second elevation angle corresponds to the platform level, and the third elevation angle corresponds to the horizon level.

### FIELD OF THE DISCLOSURE

This disclosure relates to a system and method of obstacle sensing using lidar, such as for use on a moving platform (like a vehicle).

### BACKGROUND

Lidar is a technique of detection and ranging similar to radar only using laser light as the electromagnetic radiation source. Lidar can be used, for example, to detect objects and their corresponding distances in the direction of the directed laser light. However, there are a number of non-trivial issues associated with detecting objects using lidar.

### BRIEF DESCRIPTION OF THE DRAWINGS

FIG. 1 is a schematic diagram of an example environment in which an obstacle sensing system using lidar is deployed, according to an embodiment of the present disclosure.

FIG. 2 is a block diagram of an example obstacle sensing lidar system, according to an embodiment of the present disclosure.

FIG. 3 is a block diagram of an example readout integrated circuit (ROIC), such as for use with the obstacle sensing lidar system of FIG. 2, according to an embodiment of the present disclosure.

FIG. 4 is a block diagram of an example near-infrared (NIR) radiation sensor, such as for use with the ROIC of FIG. 3, according to an embodiment of the present disclosure.

FIG. 5 is a schematic diagram of an example deployment of an obstacle sensing system using lidar, according to an embodiment of the present disclosure.

FIG. 6 is a flow diagram of an example method of obstacle sensing using lidar, such as with the obstacle sensing lidar system of FIG. 2, according to an embodiment of the present disclosure.

Although the following Detailed Description will proceed with reference being made to illustrative embodiments, many alternatives, modifications, and variations thereof will be apparent to those in light of the present disclosure.

### DETAILED DESCRIPTION

An obstacle sensing lidar system is provided. In an embodiment, the lidar system includes a laser source, a laser sensing device, and elevation circuitry. The laser source emits, for example, eye-safe near-infrared (NIR) laser radiation in a horizontal fan-beam pattern. This emission can occur, for instance, in front of a moving platform, such as a vehicle on a roadway, although other applications will be apparent in light of this disclosure. In an embodiment, the laser source is a pulse laser diode configured to emit NIR light of 850 nanometer (nm) wavelength through fan-beam optics at an adjustable angle of elevation. The pulse rate is between 40 hertz (Hz) and 1200 Hz.

In some such embodiments, the span angle of the horizontal fan-beam is at least 60°, and the beam is directed at a particular angle of elevation (or range of elevation) in front of the moving platform. This allows objects within a given range of the platform to be impinged by the beam, which in turn causes a reflected beam to be returned back to the platform. Although a number of configurations can be used, in some embodiments, the sensing device is an array that includes a row of 100 or more NIR pixels to sense corresponding reflections of the emitted laser beams off obstacles in front of the moving platform. Each pixel of the sensing device can generate a detection signal in response to light impinging thereon. To this end, each pixel of the array can be thought of as an individual sensor, according to some example embodiments. The obstacles in front of the vehicle can include, for example, things such as other vehicles and roadway fixtures, such as walls, guard rails, vegetation, fences, and the like. In one specific example embodiment, the sensing device incorporates optics to focus the incoming beams at a spacing of 21 milliradians (mrads, or 1.2°) or smaller on the array of pixels, so as to cover an azimuthal field of view of at least 60° at the given angle of elevation (or range of elevation) in front of the moving platform.

The elevation circuitry adjusts the angle of elevation of the emitted laser radiation. In an embodiment, the elevation circuitry adjusts between three or more angles of elevation at a time, including at least one angle of elevation at the surface or roadway level, at least one angle of elevation at the platform or vehicle level, and at least one angle of elevation at the horizon level (e.g., just above the vehicles). In still other embodiments, different sets of angles of elevation are used over time, for example, to adjust for changes in environment (e.g., climbing or descending, changes in the roadway ahead, traffic density, and the like). In some embodiments, the lidar system is further configured to estimate sizes of the obstacles (e.g., horizontal widths of objects) from corresponding consecutive sensed reflections off the obstacles at the angle of elevation in front of the moving platform. In some such cases, note that seemingly distinct small obstacles sensed at the same (or similar) distance by consecutive adjacent sensors can be treated as a single obstacle having greater width.

As previously noted, in some embodiments, the emitted NIR laser radiation is eye-safe, such as to safely accommodate oncoming drivers or pedestrians. As used herein, eye-safe refers to any laser radiation that is benign to the human eye (will not damage an average human eye for a relevant period of time in a given application), or otherwise characterized as eye-safe by a reputable and appropriate standards body or authority. As will be appreciated, the eye-safe characterization is not limited to a static set of laser parameters; rather, an eye-safe determination depends on the interaction of laser parameters such as wavelength, pulse length, pulse pitch, exposure time, and power density. For instance, higher wavelengths and/or power densities for shorter exposure durations may still be considered eye-safe; numerous other permutations will be apparent.

In some such example embodiments, the laser radiation is at least 850 nanometers in wavelength, the laser pulse duration is at least 1 nanosecond (ns), each pulse of the laser radiation does not exceed one microjoule (μJ) of light energy per square centimeter (cm²) of output aperture of the laser source, and consecutive pulses of the laser radiation are at least 500 microseconds (μs) apart. In some such embodiments, the sensing device includes a plurality of rows of NIR pixels, such as an array of 100×100 pixels arranged in rows by elevation and in columns by azimuth. In some such embodiments, selecting the different angles of elevation includes sensing different sets of one or more corresponding rows of the sensor array (e.g., lower set, middle set, and upper set, with or without overlap between the sets). In some such embodiments, the sensor array is part of a readout integrated circuit (ROIC) for sensing the objects' distances and positions from reflected NIR radiation. In some such embodiments, the NIR pixels of the sensor array are processed asynchronously on the ROIC in response to sensing a triggering amount of reflected NIR radiation. Numerous other embodiments and variations will be apparent in light of the present disclosure.

### General Overview

As mentioned above, there are a number of non-trivial performance issues associated with detecting objects using lidar. For example, in a crowded setting, such as a busy freeway or roadway, it can be difficult to obtain high angular accuracy (e.g., within a small number of millirads, or within 1°), tight range resolution (such as within a few feet), wide azimuthal coverage (e.g., 80° or 90°) and effective range (such as 150 or 200 yards) in a practical lidar system for ordinary automobiles. Laser emission can be dangerous to other drivers or pedestrians, complex systems can be impractical for widespread use, and sacrificing one or more of angular accuracy, range resolution, field of view (FOV), and effective range can render the system unfit for uses such as vehicle assist and autonomous driving.

Accordingly, in an embodiment of the present disclosure, a laser detection semiconductor ROIC is used in conjunction with an NIR pulse laser in a fan-beam configuration. The ROIC has an array (such as 100×100, 200×200, or 400×400) of NIR pixels (also referred to as NIR sensors herein). The fan-beam effectively provides a two-dimensional (2D) horizontal cut above the roadway providing say, 100, 200, or 400 data points of the 2D (horizontal) object profile at that elevation above the roadway. To this end, if any objects are present in the sensor's field of view at that elevation, then those objects will be represented in the reflected portions of the fan-beam. In one or more embodiments, each NIR pixel or sensor senses a triggering amount of NIR radiation, such as a programmable or otherwise settable threshold amount. In one or more embodiments, each triggering NIR sensor in a particular column (such as in a particular row corresponding to a particular angle of elevation) signals an asynchronous column request for processing by the ROIC. After storing the value of a common clock signal and receiving the corresponding row request from the triggering sensor or pixel, the ROIC generates a time-stamped event for that sensor or pixel and outputs the event for post processing.

Each such triggering generates a corresponding time-stamped event for that particular NIR sensor for post processing. In one such embodiment, the time stamp represents a time increment, in units of the common clock signal, such as 1, 2, or 5 nanoseconds (ns), corresponding to 1, 2, or 5 feet of round trip distance, or to 0.5, 1, or 2.5 feet of one-way distance, of the emitted NIR radiation and the received reflected radiation off corresponding obstacles. In some embodiments, the reflected NIR radiation from distant obstacles (such as 150 or 200 yards) is so faint when it reaches the sensor array that it takes the better part of a pulse (such as 100 ns) to trigger the sensor(s) upon which the reflected beam impinges. Meanwhile, nearby obstacles can trigger the impinged sensor(s) in a relatively shorter period of time (such as 10 ns or less). In an embodiment, discrepancy in triggering times due to the slower sensing between sensors at significantly different distances can be corrected, for instance, in post processing to bring the triggering times in line with the actual distances to the corresponding obstacles.

In some embodiments, the fan-beam horizontally spreads the laser pulse in a wide angle, such as 60°, 70°, 80°, or 90° of azimuthal coverage or field of view (FOV), which provides sufficient coverage of the traffic or other obstacles in front of the vehicle. In some such embodiments, the pixels or sensors in the row are arranged uniformly to sense different angular increments or sectors, such as uniform sectors of 3, 6, 11, 16, or 21 milliradians (millirads or mrads), to sense the corresponding reflected fan-beam radiation. In some embodiments, the emitted radiation is considered eye-safe (such as Class 1 or Class 1M) when it leaves the fan-beam laser source. For example, in one embodiment, the laser source is 850 nm pulse laser configured in a 90° fan-beam pattern with an effective range of 150 meters. In one particular such embodiment, the laser generates 429 watts (W) of peak power with 100 ns pulses of 42.9 microjoules (μJ) per pulse with an output aperture of at least 43 cm² (e.g., to stay Class 1 compliant), such as with a 3-inch lens.

Driving such a large array of sensors/pixels can be very processing intensive and detrimental to real-time responsiveness (e.g., if each of several hundred rows of sensors/pixels requires a separate pulse, and the pulses have to be spaced apart for reasons such as eye safety). Accordingly, in one or more embodiments, elevation circuitry is provided to only select a few of the rows (such as between three and ten) to drive at a time. In some embodiments, real-time responsiveness of the lidar system is maintained and safe levels of the NIR laser radiation are emitted by driving the selected rows between 15 and 120 times per second. In some such embodiments, note that processing load is effectively managed by reducing the number of rows to be read out and processed (rather than all rows of the array, only a subset of rows of the array is read out at corresponding elevations). For applications such as vehicle assist or autonomous driving, note that vertical (elevation) resolution is not necessarily as important as horizontal (azimuth) resolution, so a relatively small set of rows can be scanned. For instance, in one such embodiment, the scanned rows include one to ten rows corresponding to the surface (e.g., street or roadway) level, one to ten rows corresponding to the platform or traffic level, and one to ten rows corresponding to the horizon (such as treetop or just above the traffic) level.

In some embodiments, the set of rows to be read out and processed (and their corresponding elevations) changes over time to account for factors such as orientation of the vehicle (e.g., climbing or uneven terrain), calibration of the sensor array, traffic conditions, and the like. In some embodiments, a few extra rows are driven between the lowest and highest elevations (such as between 6 and 10 total rows) without changing over time, the extra rows providing the extra coverage during more unusual circumstances. In some embodiments, only a small percentage (such as between 1 and 10 percent) of the rows is driven at any given time. In some embodiments, at least two different rows corresponding to the platform or traffic level are driven (since that level is particularly important for vehicle assist or autonomous driving). In one or more embodiments, a vibrational optic is used with the laser source to vary the fan-beam up and down (and possibly left and right) to provide the corresponding selection of rows (and possibly columns) between the lowest (such as roadway level) and highest (e.g., horizon level). Numerous other example embodiments and configurations will be apparent in light of this disclosure.

### System Architecture

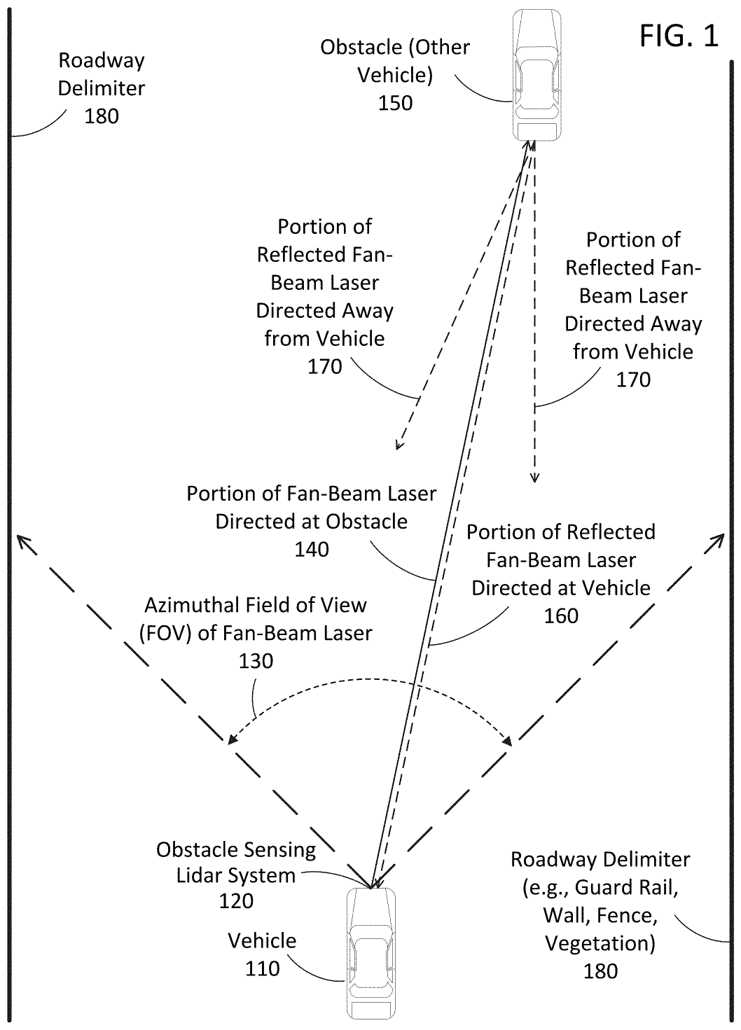

FIG. 1 is a schematic diagram (plan view) of an example environment in which an obstacle sensing system using lidar 120 is deployed, according to an embodiment of the present disclosure. In some embodiments, the lidar system 120 is deployed on a moving vehicle 110, such as the front of the vehicle 110, to sense obstacles (e.g., traffic, walls, barriers, such as other vehicle 150), in or near the roadway (as delimited by roadway delimiters 180, such as guard rails, walls, fences, or vegetation). The lidar system 120 has a 90° field of view 130 (in the azimuthal direction). For example, the lidar system 120 emits NIR laser radiation in a 90° horizontal fan-beam pattern 130. The emitted NIR laser radiation travels at the speed of light and at a particular angle of elevation from the vehicle 110 (such as at traffic level). In an embodiment, the emitted radiation is evenly distributed within the FOV 130, including a portion 140 directed at an obstacle 150 (e.g., another vehicle). The portion 140 reflects or back scatters off the obstacle 150, sending portions 170 or most of the reflected radiation away from the vehicle 110, and sending a small portion 160 of the reflected radiation back to the vehicle 110, and in particular, to the lidar system 120.

In an embodiment, the lidar system 120 sends a pulse of NIR radiation, such as a pulse between 5 ns and 100 ns. The lidar system 120 receives the reflected NIR radiation, which is sensed by one or more NIR sensors (pixels) arranged in a row (e.g., 100, 200, or 400 NIR sensors/pixels), such as in an array of such rows. Each sensor/pixel senses a particular portion of the FOV 130 at the angle of elevation of the fan-beam laser for NIR radiation reflected back to the lidar system 120. When sufficient radiation is received, such as a triggering amount, the time or value of the common clock signal is stored. Since the time correlates linearly with the distance between vehicle 110 and the obstacle 150 (e.g., light travels at about one foot per ns), the stored clock value (or, more precisely, the time between the start of the fan-beam pulse and the stored clock value) can serve as a measurement of the distance between the vehicle 110 and the obstacle 150. For instance, the round-trip time for the emitted light to reflect off the obstacle 150 and be sensed by the lidar system 120 can be divided by two and multiplied by the speed of light to determine the distance between the vehicle 110 and the obstacle 150.

For obstacles as large as the obstacle 150, numerous consecutive NIR sensors/pixels in the lidar system 120 may receive sufficient reflected radiation to trigger and store the same or similar values of the common clock signal (corresponding to the portion of the FOV 130 taken up by the obstacle 150). In some embodiments, the lidar system 120 interprets these consecutive same or similar sensings as indicating a single obstacle of a corresponding width (at the sensed distance and angular portion of the FOV 130).

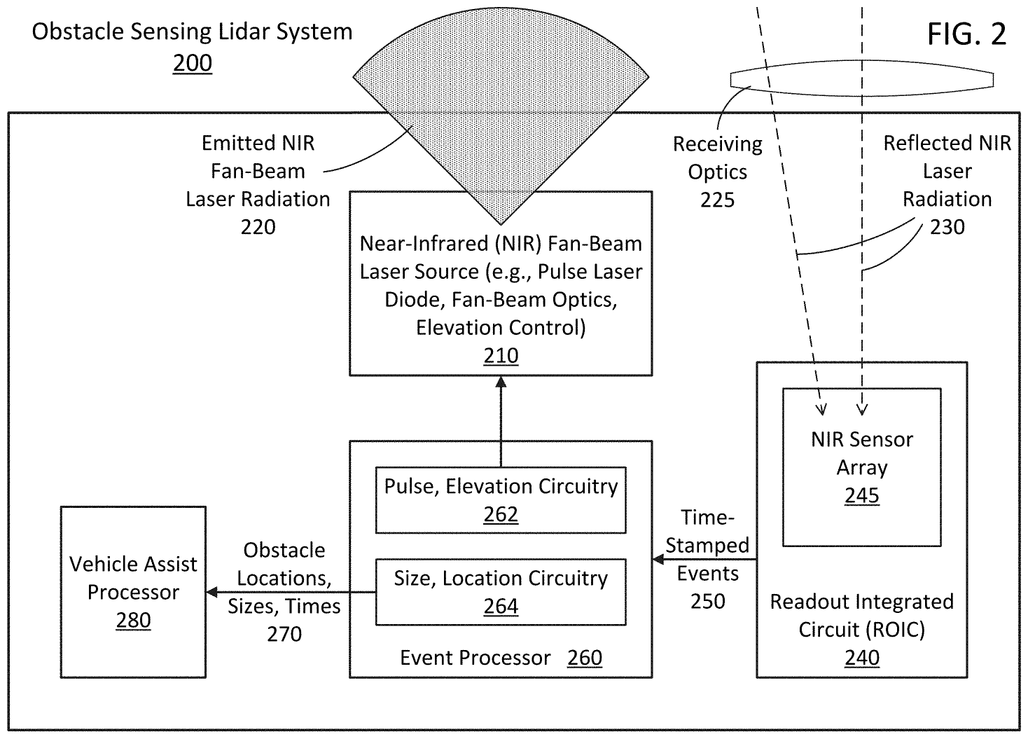

FIG. 2 is a block diagram of an example obstacle sensing lidar system 200, according to an embodiment of the present disclosure. The circuity of the lidar system 200 can be fabricated, for example, as an integrated circuit (IC) using standard IC fabrication techniques such as photolithography. For example, the circuitry can be fabricated in a semiconductor fabrication technology, such as complementary metal-oxide semiconductor (CMOS), p-type MOS (PMOS), or n-type MOS (NMOS), to name a few. In addition, the laser optics can use commercially available components such as an 850-nm pulse laser diode, a fan-beam spreader, and corresponding receiving optics to focus the reflected laser radiation on an array of NIR sensors (pixels). The NIR sensor array can be, for instance, a standard NIR focal-plane array fabricated on silicon-based semiconductor structures configured to sense NIR radiation, for example, between 810 nm and 890 nm in wavelength. Other semiconductor material systems can be used to implement the sensor array, such as group III-V materials (e.g., indium gallium arsenide, or InGaAs-based sensor array).

While circuits are illustrated as being made up of other circuits by function, in other embodiments, two or more circuits may be combined into a single circuit performing the functionality of the two or more circuits. In still other embodiments, a single circuit can be divided into two or more circuits, each performing separate functions performed by the single circuit. As will be further appreciated, a circuit as used herein is a physical structure capable of carrying out one or more functionalities as variously provided herein. For example, the structure can be hardware such as purpose-built semiconductor (e.g., gate-level logic or application specific integrated circuit) or a printed circuit board populated with discrete components configured and arranged to carry out the various functionalities provided herein. Numerous such embodiments and configurations will be appreciated in light of this disclosure.

In some embodiments, the circuitry of the lidar system 200 is implemented in hardware or software, such as a custom circuit or a field programmable gate array (FPGA) configured to carry out the function of the circuit. In some embodiments, the circuitry of the lidar system 200 is implemented through general-purpose computer hardware configured (e.g., through software, firmware, programmable logic, to name a few) to carry out the tasks assigned to the circuit.

In the lidar system 200, NIR laser radiation 220 is emitted from a corresponding laser source 210 in a fan-beam pattern (such as between 60° and 90°, or between 60° and 120°) at a particular (and adjustable or variable) angle of elevation. In some embodiments, the laser source 210 uses a settable or mechanical angle of elevation, such as a vibrational optic that moves the fan-beam up and down in an oscillating pattern. In some such embodiments, the vibrational optic oscillates in a pattern between 100 hertz (Hz) and 400 Hz. The oscillating pattern can be, for example, up and down, with or without some left and right rotation mixed in. As such, in an embodiment, every several milliseconds (msec, such as between 2 and 10 msec), the pattern repeats, and within that time, elevation circuitry 262 waits until the fan-beam optic is at the desired elevation (or azimuth), and direct the laser source 210 to emit a pulse of fan-beam NIR laser radiation at that time.

In some embodiments, the laser source 210 emits pulses at a frequency between 40 Hz and 1200 Hz. Emitting less than 40 pulses per second can reduce the responsiveness or real-time performance of the system to monitor the obstacles in front of the vehicle in a moving environment (e.g., traffic on a busy freeway). Emitting more than 1200 pulses per second can pose a safety risk to people (e.g., pedestrians, other drivers) exposed to the emitted NIR laser radiation 220.

The emitted NIR radiation 220 reflects off obstacles, portions of which return to the lidar system 200 as reflected NIR laser radiation 230. The received reflected laser radiation 230 passes through receiving optics 225 to focus the radiation on an NIR sensor array 245, which is part of a readout integrated circuit (ROIC) 240, such as a laser detection ROIC. In some embodiments, the receiving optics 225 focus the incoming radiation 230 on one or more corresponding rows of NIR sensors/pixels of the sensor array 245, where each row of sensors/pixels (or group of rows) in the sensor array 245 corresponds to a different angle of elevation of the incoming (reflected) NIR radiation. Each NIR sensor/pixel in the sensor array 245 measures its corresponding incoming reflected radiation. For example, each NIR sensor/pixel includes material sensitive to the emitted NIR laser radiation. When a triggering amount of NIR radiation is sensed by the NIR sensor/pixel, the sensor/pixel stores the value of a common clock signal (or takes some action that causes the value of a common clock signal to be stored), such as in a local memory or storage cell.

As the NIR radiation sensors/pixels in the sensor array 245 sense the NIR radiation, events are generated by the ROIC 240, one event per triggering sensor/pixel. In one example, the location and identification of the triggering sensor/pixel, together with a time stamp of the triggering, is utilized. These time-stamped events 250 are sent to an event processor 260, which includes size and location circuitry 264 to process and model the events 250 over time to discern obstacle distances, locations, sizes, and times 270 based on events of particular sensors/pixels or groups of adjacent sensors/pixels. The obstacle locations, sizes, and times 270 are output from the event processor 260 to a vehicle assist processor 280 for various uses, such as assisting the driving of the vehicle (e.g., driving a display of the obstacles in front of the vehicle), being part of an autonomous driving system for the vehicle, or assisting in automatic features, such as autonomous braking to avoid collision with an obstacle. In some embodiments, the vehicle assist processor 280 is part of a suite of components for autonomous driving. Other components can include navigation aids, roadway and lane boundary detectors, and automatic controls such as for steering, accelerating, and braking.

The event processor 260 further includes pulse and elevation circuitry 262 that controls the elevation of the emitted NIR laser radiation 220 (such as when and how long to emit the NIR laser radiation 220 by the laser source 210). In an embodiment, an oscillating optic oscillates the outgoing fan-beam NIR laser radiation in an up and down elevation pattern at frequencies, for example, between 100 Hz and 400 Hz. Accordingly, in some embodiments, the pulse and elevation circuitry 262 times the pulses of the laser source 210 for when the optic is at the desired elevation. In addition, the returned, time-stamped events 250 from the ROIC 240 will provide feedback to the pulse and elevation circuitry 262 for whether the desired sensors/pixels in the sensor array 245 are triggering, or whether the pulse and elevation circuitry should recalibrate (e.g., recharacterize) the vibrational optic for future pulses to take place when the optic is at the desired elevation.

In an embodiment, the vibrational optic also has a side-to-side component in its oscillating pattern. This can allow, for example, wider transmissions of a particular elevation by emitting, say, a 60° fan-beam pattern on the left half of the front field of view, and also emitting the 60° fan-beam pattern on the right half of the front field of view (e.g., 120° field of view coverage) when the optic has moved to that corresponding location in its vibrating pattern. In an embodiment, the pulse and elevation circuitry 262 also adjusts the particular elevation (or azimuth) to respond to particular situations, such as climbing or dropping, or adjust the laser radiation 220, such as using a shorter pulse (like 5 ns) to detect nearby objects better with less noise from distant objects (such as in heavy traffic), but using a longer pulse (like 100 ns) to detect distant objects better (such as in light or no traffic). In one embodiment, the NIR sensor array 245 is arranged in a single row, wherein incoming signals are directed by a lensing arrangement to the row of sensors. Further note that the sensors or pixels can be sized as desired, and in some cases, are vertically elongated or otherwise taller than they are wide.

The size of the sensor array 245 may be 200×200 sensors/pixels, but other sizes are also possible, such as 300×300, 400×400, 100×100, and 320×240, to name a few. When the receiving optics evenly distribute the FOV among a row of sensors, such as a 90° FOV among 100 sensors/pixels in the row, each sensor/pixel receives a corresponding 15.7 milliradians (millirads or mrads) portion of the FOV. This 15.7 mrads per sensor/pixel is also referred to as the spatial resolution (or just resolution) or instantaneous field of view (IFOV). Likewise, an 80° FOV among 200 sensors/pixels results in a 7.0 mrad resolution or IFOV, while a 60° FOV among 400 sensors/pixels results in a 2.6 mrad resolution. For comparison, there are about 17.5 mrads in a degree. Embodiments of the present disclosure have an IFOV of 21 mrads (1.2°) or smaller (such as 3, 6, 10, 15, or 21 mrads, or 0.2°, 0.4°, 0.6°, 0.9°, or 1.2°) to obtain sufficient spatial resolution to detect obstacles and their corresponding horizontal sizes in front of the moving platform employing the lidar system.

In some embodiments, vertical (elevation) resolution is less than horizontal resolution (e.g., there are fewer rows than columns in the array). Accordingly, there may be only a single row of sensors/pixels, or ten rows, with corresponding approximations of vertical resolution based on factors such as emitting elevation of the NIR laser radiation.

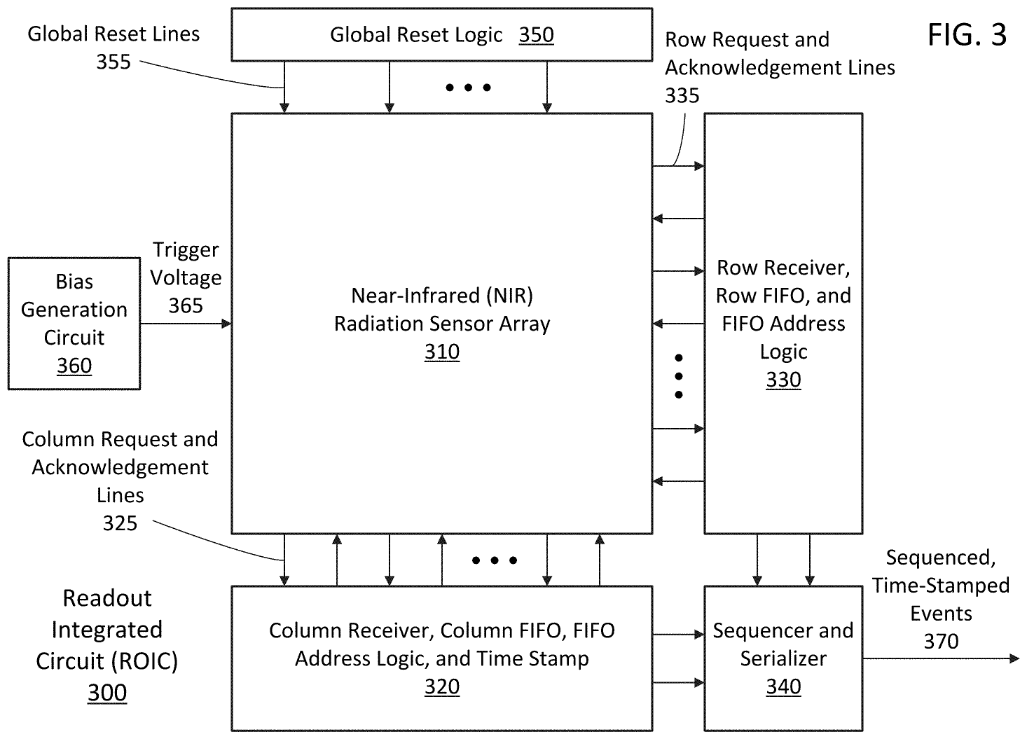

FIG. 3 is a block diagram of an example readout integrated circuit (ROIC) 300, such as for use with the obstacle sensing lidar system 200 of FIG. 2, according to an embodiment of the present disclosure. The ROIC 300 includes a near-infrared (NIR) radiation sensor array 310, column receiver, column first-in first-out (FIFO), FIFO address logic, and time stamp circuit 320, row receiver, row FIFO, and FIFO address logic circuit 330, a sequencer and serializer circuit 340, a global reset logic circuit 350, and a bias generation circuit 360. It should be noted that while in the ROIC 300 of FIG. 3, columns are arranged vertically and rows are arranged horizontally, this is for convenience of description. In some other embodiments, rows are arranged vertically while columns are arranged horizontally. Likewise, while in the ROIC 300 of FIG. 3, columns are processed first and then rows, with the time stamp logic in the column receiver 320, in some other embodiments, rows are processed first and then columns, with the time stamp logic in the row receiver 330.

In an embodiment, the sensors/pixels in the sensor array 310 are threshold-detecting sensors/pixels, sensing portions of the NIR spectrum used by a corresponding laser source, such as laser source 210 of FIG. 2. In some embodiments, the sensors/pixels are arranged in rows and columns, and communicate via corresponding column request and acknowledgement lines 325 and row request and acknowledgement lines 335. In some such embodiments, the sensors/pixels are arranged in columns by the column request and acknowledgement lines 325, and in rows by the row request acknowledgement lines 335, with one column request line and one column acknowledgement line per column of sensors/pixels, and one row request line and one row acknowledgement line per row of sensors/pixels. In an embodiment, each sensor/pixel is uniquely addressed by a corresponding pair of column request and row request lines as well as a corresponding pair of column acknowledgement and row acknowledgement lines.

Each of the column request and column acknowledgement lines is commonly coupled to the sensors/pixels in the corresponding column, while each of the row request and row acknowledgement lines is commonly coupled to the sensors/pixels in the corresponding row. In an embodiment, the sensors are concurrently or simultaneously reset through the global reset logic circuit 350, which sends a global reset command (such as between laser pulses) to the sensors/pixels through global reset lines 355 (e.g., each commonly coupled to all the sensors/pixels in the same column). In an embodiment, the column request line is for sending a column request to the column receiver 320, while the column acknowledgement line is for receiving a column acknowledgement from the column receiver 320. Likewise, the row request line is for sending a row request to the row receiver 330, while the row acknowledgement line is for receiving a row acknowledgement from the row receiver 330. The ROIC 300 further has a bias generation circuit 360 for generating trigger voltage 365 (e.g., biasing voltage or calibrating voltage or baseline voltage for controlling the triggering of sensors/pixels to incoming NIR radiation).

In further detail, in one or more embodiments, the sensor array is configured for sensing triggering amounts of NIR radiation, such as reflected NIR radiation from a laser source (such as laser source 210) reflecting off obstacles in front of a moving platform. For example, in an embodiment, the sensors/pixels of the array are configured to sense only specific frequencies or wavelengths, such as between 810 nm and 890 nm wavelength radiation as emitted by 850 nm pulse laser diodes. When a sufficient level (such as a programmable level, as with trigger voltage 365) of NIR radiation is incident upon sensors of the array 310, a sensor/pixel triggers, and it sends column and row requests through its corresponding column request and row request lines, which are received by the column receiver 320 and row receiver 330, respectively.

The time between the laser source emitting the NIR radiation and the sensor/pixel detecting the triggering level of NIR radiation provides an approximate measure of the distance between the laser source and the corresponding obstacles reflecting the NIR radiation. In some embodiments, follow-on event processing corrects small discrepancies due to effects such as more distant obstacles taking longer to reflect a triggering level of NIR radiation that is received by the sensor array 310. For example, close obstacles (such as 10 meters or less) may trigger the corresponding sensors/pixels immediately (such as through reflecting less than the first 5 ns of a laser pulse), while more distant obstacles (such as 150 meters or 200 meters) may need to reflect as much as 100 ns of laser pulse, which adds close to 100 ns of extra time to the round-trip time (roughly 1000 ns) it takes the laser light to reach and return from the more distant obstacles. In some embodiments, this roughly 10% discrepancy (for these example numbers) is corrected through post processing.

In some embodiments, the column request is sent first. In some other embodiments, the row request is sent first or both requests are sent concurrently. The column receiver 320 processes the column requests as they are received. In an embodiment, the column receiver 320 monitors the separate column request lines 325, and processes one of the columns when a column request is received from the corresponding column request line. In some embodiments, the column receiver 320 scans the column request lines in round robin fashion, processing the next column that sends a column request. In this manner, the column receiver 320 does not favor one column over another, and processes each column's requests with good temporal correlation. For example, in an embodiment, all the column requests that arrive in the same time interval (such as a few ns, or 10 ns) are assigned the same time stamp by the column receiver 320.

In some embodiments, the column receiver 320 sends a column acknowledgement through the corresponding column acknowledgement line. This is received by every sensor/pixel in the corresponding column. In an embodiment, the column receiver 320 also sends the column address and time stamp to the sequencer 340, which processes events for all the triggering sensors/pixels in this column with the same time stamp. In some embodiments, time stamping is saved until event processing (e.g., off-chip from the ROIC 300). However, this introduces some delay between receipt of the triggering event and the eventual time-stamping of the corresponding events, and the delay may not be desired for the purpose here (e.g., to measure round-trip flight time of laser radiation). Usually, only one row of sensors/pixels is being driven at a time (corresponding to the particular elevation being pulsed with the fan-beam laser radiation). Accordingly, by processing the columns first, only one corresponding sensor/pixel in the column is likely to be triggering during the time window.

At this point, every triggering sensor/pixel in the same column that receives the column acknowledgement sends their corresponding row requests through their corresponding row request lines 335. The row receiver 330 receives these row requests (e.g., by scanning all the row request lines), sending acknowledgements to each of the rows that sent row requests through their corresponding row acknowledgement lines as well as sending the corresponding row addresses to the sequencer 340. The sequencer 340 combines the current column address and time stamp sent by the column receiver 320 with each of the different row addresses from the row receiver 330 and generates a time-stamped event for each of the different row addresses (and that all share the same column address and time stamp).

In an embodiment, when the triggering sensors/pixels in the column receive the corresponding row acknowledgements, those sensors/pixels are reset and are ready to be triggered again. In another embodiment, when the triggering sensors/pixels in the column receive the corresponding row acknowledgements, their respective request lines are reset and those sensors/pixels wait for a global reset (to reduce or prevent triggering twice on the same laser pulse). This clears all the column and row requests from these triggering sensors/pixels as well. Processing then resumes with the column receiver 320 scanning for another column that sent a column request.

Because of the column request and row request lines, in some embodiments, the ROIC 300 avoids scanning every sensor/pixel and instead scans entire columns at a time, looking for a column request (that represents one or more sensors/pixels triggering in the corresponding column). This generates the next column address for the sequencer 340, which combines the column address and time stamp with the corresponding row addresses for the triggering sensors/pixels in that column and generates a separate time-stamped event for each one. The sequencer 340 serializes these events 370 and sends them to an event processor (e.g., off chip, such as event processor 260 of FIG. 2) to decode patterns of the received NIR radiation over time and their corresponding obstacles, locations, distances, and sizes from the sensor array 310. In an embodiment, the sequencer 340 sends the events 370 over a serial interface, such as a serial periphery interface (SPI). In an embodiment, the event processor sends these decoded patterns and their locations to an autonomous driving system (such as the vehicle assist processor 280) to control the vehicle (or platform vehicle).

For various purposes, such as initializing the sensor array 310, clearing an abnormal condition, resetting the sensor array after a laser pulse, or the like, the global reset logic 350 is provided, together with corresponding global reset lines 355. In an embodiment, each global reset line 355 resets every sensor/pixel in a corresponding column. In another embodiment, the global reset lines 355 are arranged by row. In some embodiments, the global resetting is similar to the local resetting that takes place in each sensor/pixel when its corresponding column and row acknowledgements are received. In other embodiments, sensors/pixels whose NIR detection circuits have triggered are reset during the global reset (e.g., between laser pulses), but not during the individual sensor/pixel resets that take place after a triggering event is processed by the corresponding column request and acknowledgement lines 325 and the corresponding row request and acknowledgement lines 335.

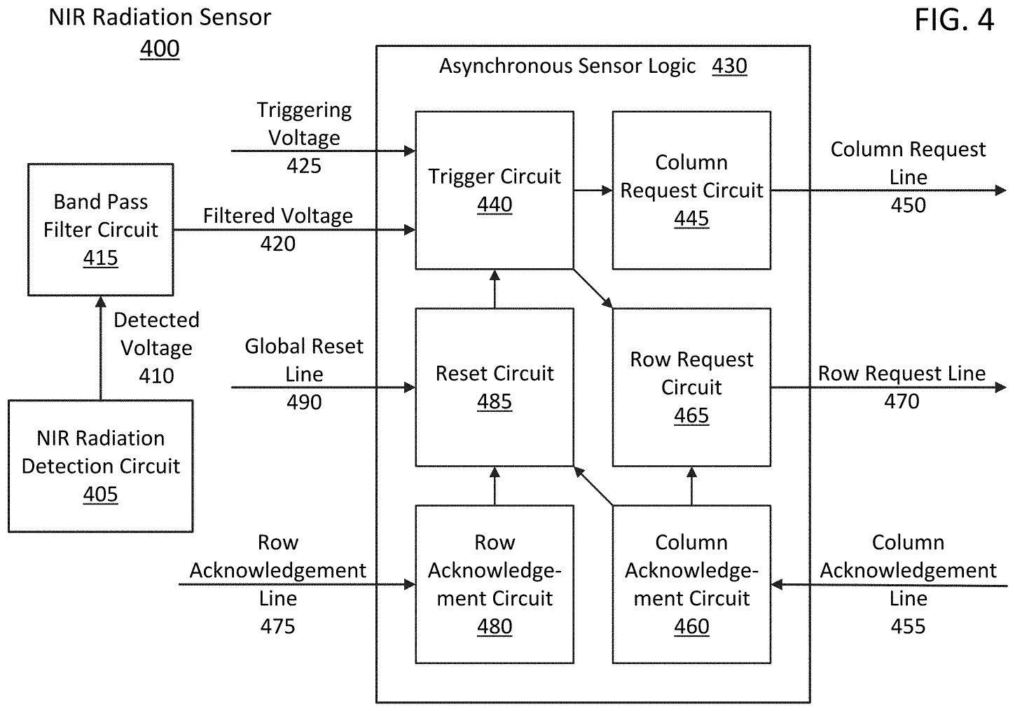

FIG. 4 is a block diagram of an example near-infrared (NIR) radiation sensor 400, such as for use with the ROIC 300 of FIG. 3, according to an embodiment of the present disclosure. The NIR radiation sensor 400 includes a NIR radiation detection circuit 405, a filter such as a band pass filter circuit 415, and an asynchronous sensor logic circuit 430. In some embodiments, the detection circuit 405 is an open circuit photo-diode, which detects light (e.g., visible and IR radiation) as voltages, such as detected voltage 410. In one such embodiment, the detected voltage 410 from the detection circuit 405 is input to the band pass filter circuit 415, which filters out detected optical frequencies outside of the intended band (e.g., NIR, such as emitted radiation from the laser source, as in laser source 210) and outputs the filtered voltage 420 to the asynchronous sensor logic 430.

The asynchronous sensor logic circuit 430 includes a trigger circuit 440, a column request circuit 445, a column acknowledgement circuit 460, a row request circuit 465, a row acknowledgement circuit 480, and a reset circuit 485. In an embodiment, the trigger circuit 440 includes a comparator that compares the filtered voltage 420 from the band pass filter circuit 415 with a triggering voltage 425 (e.g., a tunable voltage that can be calibrated to improve or optimize obstacle detection performance, such as in the particular application or environment in which it is being used). In one example, the trigger voltage 425 is set to be above the noise floor of the array so that the detected signals are likely from the reflected laser signals. According to one embodiment, the trigger voltage 425 is dynamic and can be adjusted by an operator or by the internal processing.

When the comparator determines that the filtered voltage 420 exceeds the triggering voltage 425, the sensor 400 triggers (e.g., goes from a reset state to a triggered state). Once in the triggered state, the trigger circuit 440 lets the column request circuit 445 and the row request circuit 465 know that the sensor 400 has triggered. In response, the column request circuit 445 sends a column request along the column request line 450 (which, for example, joins the request with any other column requests from sensors in the same column). For instance, in an embodiment, the column request line 450 represents an on/off state (on for one or more sensors in the column have triggered, off for none of the sensors in the column have triggered).

After sending the column request along the column request line 450, the sensor 400 waits for a column acknowledgement along a column acknowledgement line 455. When the column acknowledgement is received by the column acknowledgement circuit 460, the column acknowledgement circuit 460 informs the reset circuit 485 that the column request can be reset and the row request circuit 465 that it is all right to send the row request. The row request circuit 465 responds by sending the row request along the row request line 470. The sensor 400 waits for a row acknowledgement along a row acknowledgement line 475. When the row acknowledgement is received by the row acknowledgement circuit 480, the row acknowledgement circuit 480 informs the reset circuit 485 that the row request can be reset.

In response to the column acknowledgement circuit 460 and the row acknowledgement circuit 480 informing the reset circuit 485 of the column acknowledgement and row acknowledgement, respectively, the reset circuit 485 resets the sensor 400 (e.g., takes the sensor 400 from the triggered state to the reset state). In an embodiment, the reset circuit 485 notifies the trigger circuit 440 to reset the sensor and other circuity that has triggered. In some embodiments, the reset circuit 485 resets the column request and the row request on the column request line 450 and the row request line 470, respectively. In some embodiments, a global reset line 490 is connected to the reset circuit 485. When the reset circuit 485 receives a global reset along the global reset line 490, the sensor resets in much the same manner as receiving both a column acknowledgement and a row acknowledgement. The global reset line 490 thus provides an efficient mechanism to reset all the sensors concurrently regardless of what states they happen to be in. In some embodiments, the global reset command is issued after each laser pulse, to prepare the sensor array for the next laser pulse.

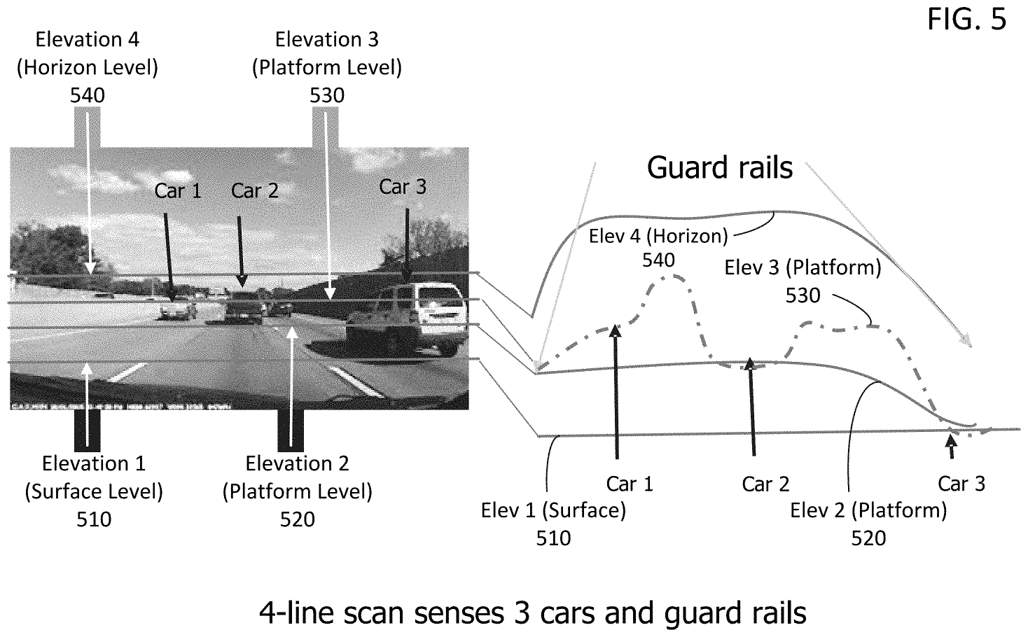

FIG. 5 is a schematic diagram of an example deployment of an obstacle sensing system using lidar, according to an embodiment of the present disclosure. On the left is a camera view of the roadway ahead of a moving vehicle equipped with an obstacle sensing lidar system, according to an embodiment of the present disclosure. Four cars are in direct view in front of the vehicle, three of which are identified (car 1, car 2, and car 3) in the photo. Four horizontal scan lines also appear in the photo, corresponding to the four angles of elevation being scanned by the lidar system. The four lines include elevation-1 510 surface level, the road immediately in front of the vehicle), elevation-4 540 (horizon level, just above the traffic), and elevation-2 520 and elevation-3 530 (platform or traffic level).

The scan lines correspond roughly to the emitted laser fan-beam patterns from the lidar system. On the right, the scan lines 510, 520, 530, and 540 are illustrated extending from left to right (row or horizontal direction), with the corresponding height (or column or vertical direction) corresponding to the distance (round-trip travel time of the emitted NIR radiation to reflect off the obstacles and return to the lidar system). As can be seen on the right, a solid close roadway appears for the elevation-1 scan line 510, a distant (with may be some trees to the side) horizon appears for the elevation-4 scan line 540, and various traffic sensings (such as for car 1, car 2, and car 3) appear for the two platform level scan lines, especially the elevation-3 scan line 530. In some embodiments, over time, an autonomous driving system or a vehicle assist processor analyzes the distance, size, and location data (as illustrated on the right) and, for example, maintains safe distances from the other obstacles. It should be noted that roadway delimiters (e.g., guard rails and walls) are sensed on the left and right edges by the different scan lines. These, too, are obstacles, just not directly in front of the moving vehicle.

Numerous other embodiments and system configurations will be apparent in light of this disclosure.

### Methodology

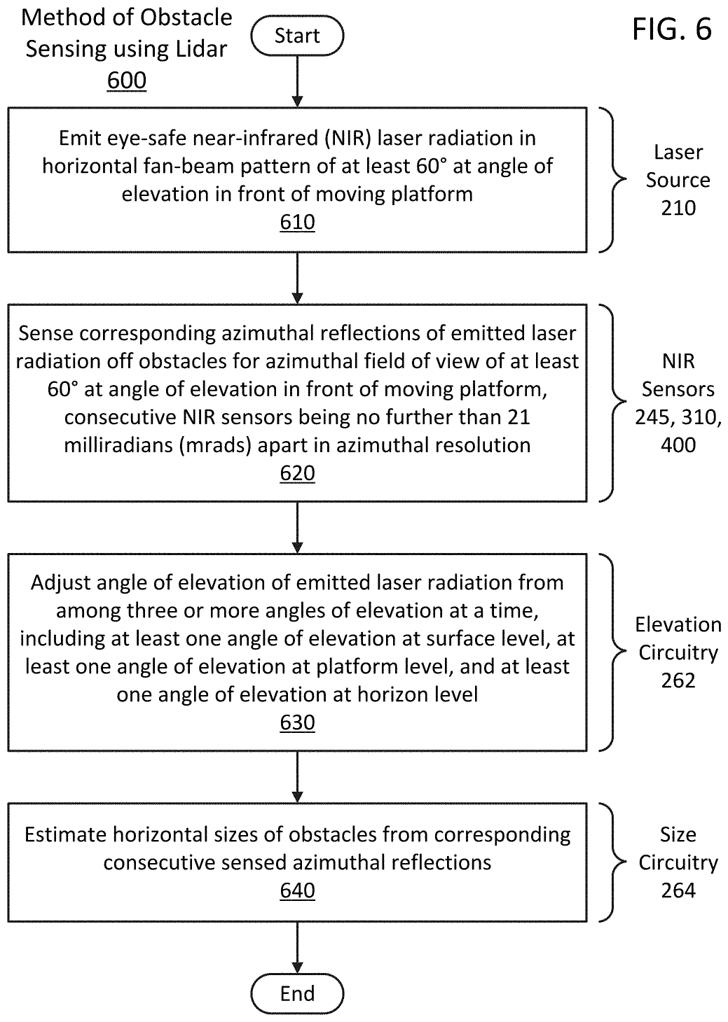

FIG. 6 is a flow diagram of an example method 600 of obstacle sensing using lidar, such as with the obstacle sensing lidar system 200 of FIG. 2, according to an embodiment of the present disclosure. The method 600 and other methods described herein may be implemented in hardware or combinations of hardware and software. For example, the method 600 may be implemented by the lidar-based obstacle sensing components and techniques of FIGS. 1-5. Throughout the description of the method 600, references may be made to example corresponding components or aspects of FIGS. 1-5. In another embodiment, the method 600 may be implemented by a custom circuit such as a ROIC with custom processing circuits (such as an FPGA), optics, and laser generation configured to carry out the method 600. In other embodiments, the method 600 may be performed in conjunction with a special purpose processor, such as a signal processor.

In some other embodiments, parts of the method 600 may be implemented as a series of computer instructions, such as software, firmware, or a combination of the two, together with one or more computer processors (e.g., one or more microprocessors). The instructions, when executed on a given processor, cause portions of the method 600 to be performed. For example, in one or more embodiments, a computer program product is provided. The computer program product includes one or more non-transitory machine-readable mediums (such as a compact disc, a DVD, a solid-state drive, a hard drive, RAM, ROM, on-chip processor cache, or the like) encoded with instructions that when executed by one or more processors cause portions of the method 600 (or other method described herein) to be carried out for obstacle sensing using lidar. In addition, while the methods described herein may appear to have a certain order to their operations, other embodiments may not be so limited. Accordingly, the order of the operations can be varied between embodiments, as would be apparent in light of this disclosure.

In a similar light, the components in FIGS. 1-4 and other circuits disclosed herein may be custom hardware circuits or general-purpose computer hardware configured (e.g., through software, firmware, programmable logic, to name a few) to carry out the tasks assigned to the circuit. While circuits are illustrated as being made up of other circuits by function, in other embodiments, two or more circuits may be combined into a single circuit performing the functionality of the two or more circuits. In still other embodiments, a single circuit can be divided into two or more circuits, each performing separate functions performed by the single circuit.

Referring to the method 600 of FIG. 6, a near-infrared (NIR) laser radiation source (such as laser source 210) is used in conjunction with a ROIC (such as ROIC 300) or other sensing circuit that has, for example, a row of 100 or more NIR radiation sensors or a sensor array (such as NIR sensor array 245) including at least 100×100 NIR sensors arranged in rows by angle of elevation and in columns by angle of azimuth. Processing begins with emitting 610, by a laser source (such as laser source 210), eye-safe NIR laser radiation in a horizontal fan-beam pattern (such as fan-beam laser radiation 220) of at least 60° at an angle of elevation in front of a moving platform (such as vehicle 110). In an embodiment, the eye-safe NIR laser radiation is at least 850 nanometers (nm) in wavelength, has a pulse duration of at least 1 nanosecond (ns), with each pulse of the laser radiation not exceeding one microjoule (μJ) of light energy per square centimeter (cm²) of output aperture of the laser source, and consecutive pulses of the laser radiation are at least 500 microseconds (μs) apart.

The method 600 further includes sensing 620, by a row of NIR sensors (such as a row of NIR sensor array 245 or NIR radiation sensor array 310), corresponding azimuthal reflections (e.g., sensor readings) of the emitted laser radiation off obstacles (such as obstacle 150) for an azimuthal field of view of at least 60° at the angle of elevation in front of the moving platform. Here, consecutive (e.g., adjacent) NIR sensors (in the row direction) are no further than 21 milliradians (mrads) apart in azimuthal resolution. The method 600 further includes adjusting 630, by elevation circuitry (such as elevation circuitry 262), the angle of elevation of the emitted laser radiation and the sensed azimuthal reflections in front of the moving platform from among three or more angles of elevation at a time. The three or more angles of elevation include at least one angle of elevation at the surface (e.g., roadway, just under the traffic) level (such as elevation-1 510), at least one angle of elevation at the platform or traffic level (such as elevation-2 520 and elevation-3 530), and at least one angle of elevation at the horizon or just over the traffic) level (such as elevation-4 540).

The method 600 further includes estimating 640, by size circuitry (such as size circuitry 264), horizontal sizes or widths of the obstacles (e.g., other vehicles) from corresponding consecutive sensed azimuthal reflections off the obstacles at the angle of elevation in front of the moving platform. In one or more embodiments, consecutive sensor readings that are the same or similar (e.g., indicative of obstacles in the same vicinity) are grouped as likely coming from a single obstacle or vehicle) being sensed from multiple consecutive angles of azimuth. Numerous other techniques and methods will be apparent in light of this disclosure.

### Further Example Embodiments

The following examples pertain to further embodiments, from which numerous permutations and configurations will be apparent.

Example 1 is an obstacle sensing lidar system including: a laser source to emit laser radiation in a horizontal fan-beam pattern of at least 60° at an angle of elevation in front of a moving platform; a sensing device having an array including a row of 100 or more near-infrared (NIR) sensors to sense corresponding reflections of the emitted laser radiation off obstacles in front of the moving platform, each NIR sensor being a pixel in the array; and elevation circuitry to adjust the angle of elevation of the emitted laser radiation to a first angle of elevation, a second angle of elevation greater than the first angle of elevation, and a third angle of elevation greater than the second angle of elevation.

Example 2 includes the lidar system of Example 1, further including a processor to estimate horizontal sizes of the obstacles from corresponding consecutive said sensed reflections.

Example 3 includes the lidar system of Example 1, wherein the emitted laser radiation is eye-safe in that the laser radiation is at least 850 nanometers (nm) in wavelength, each pulse of the laser radiation does not exceed one microjoule (μJ) of light energy per square centimeter (cm²) of output aperture of the laser source. In some such example cases, the laser radiation has a pulse duration of at least 1 nanosecond (ns), and consecutive pulses of the laser radiation are at least 500 microseconds (μs) apart.

Example 4 includes the lidar system of Example 1, wherein consecutive said NIR sensors are no further than 8 milliradians (mrads) apart in azimuthal resolution at the angle of elevation.

Example 5 includes the lidar system of Example 1, wherein the row is a first row of NIR sensors, the sensing device further including a plurality of rows of NIR sensors including the first row, each row to sense the reflections at one or more angles of elevation, each angle of elevation corresponding to one or more of the rows of NIR sensors but not all the rows of NIR sensors.

Example 6 includes the lidar system of Example 1, wherein the elevation circuitry is further to adjust the angle of elevation to a different angle of elevation selected from a set of between three and ten angles of elevation, and to select each angle of elevation from the set of between three and ten angles of elevation, the set of between three and ten angles of elevation including at least one angle of elevation corresponding to the surface level, at least one angle of elevation corresponding to the platform level, and at least one angle of elevation corresponding to the horizon level.

Example 7 includes the lidar system of Example 6, wherein the set of between three and ten angles of elevation is a first set of between three and ten angles of elevation, the elevation circuitry being further to switch to a second set of between three and ten angles of elevation different than the first set.

Example 8 includes the lidar system of Example 1, wherein the sensing device includes a common clock signal, a value of the common clock signal being stored in response to one or more of the NIR sensors sensing a triggering amount of the emitted laser radiation reflecting off the obstacles.

Example 9 includes the lidar system of Example 1, wherein the laser source is further to emit pulses of the laser radiation, the lidar system further including pulse circuitry to control the emitted pulses of the laser source.

Example 10 is a method of obstacle sensing using lidar, the method including: emitting, by a laser source, eye-safe near-infrared (NIR) laser radiation in a horizontal fan-beam pattern of at least 60° at an angle of elevation in front of a moving platform; sensing, by a row of NIR sensors, corresponding azimuthal reflections of the emitted laser radiation off obstacles for an azimuthal field of view of at least 60° at the angle of elevation in front of the moving platform, consecutive said NIR sensors being no further than 21 milliradians (mrads) apart in azimuthal resolution; and adjusting, by elevation circuitry, the angle of elevation of the emitted laser radiation from among three or more angles of elevation at a time, including at least one angle of elevation corresponding to the surface level, at least one angle of elevation corresponding to the platform level, and at least one angle of elevation corresponding to the horizon level.

Example 11 includes the method of Example 10, further including estimating, by size circuitry, horizontal sizes of the obstacles from corresponding consecutive said sensed azimuthal reflections.

Example 12 includes the method of Example 10, wherein emitting the laser radiation is eye-safe in that emitting the laser radiation includes emitting the laser radiation of at least 850 nanometers (nm) in wavelength with a pulse duration of at least 1 nanosecond (ns), each pulse of the laser radiation not exceeding one microjoule (μJ) of light energy per square centimeter (cm²) of output aperture of the laser source, and consecutive pulses of the laser radiation being at least 500 microseconds (μs) apart.

Example 13 includes the method of Example 10, wherein the row of NIR sensors is a first row of a plurality of rows of NIR sensors, and sensing the azimuthal reflections includes sensing, by a corresponding three or more of the rows of NIR sensors, corresponding azimuthal reflections of the emitted laser radiation off the obstacles at the three or more angles of elevation.

Example 14 includes the method of Example 13, wherein the plurality of rows includes 100 or more rows, adjusting the angle of elevation includes adjusting the angle of elevation to a different angle of elevation selected from a set of between three and ten angles of elevation, and selecting each angle of elevation from the set of between three and ten angles of elevation, and sensing the azimuthal reflections includes sensing, by a corresponding between three and ten of the rows of NIR sensors, corresponding azimuthal reflections of the emitted laser radiation off the obstacles at the between three and ten angles of elevation.

Example 15 includes the method of Example 10, wherein sensing the azimuthal reflections includes storing a value of a common clock signal in response to one or more of the NIR sensors sensing a triggering amount of the emitted laser radiation reflecting off the obstacles.

Example 16 is an obstacle sensing lidar system including: a laser source to emit eye-safe near-infrared (NIR) laser radiation in a horizontal fan-beam pattern of at least 60° at an angle of elevation in front of a moving platform; a readout integrated circuit (ROIC) including a common clock signal, and an array of NIR sensors arranged in at least 100 rows by elevation sensed and including one row corresponding to the angle of elevation, and in at least 100 columns by azimuth sensed and spanning an azimuthal field of view of at least 60°, a value of the common clock signal being stored in response to one or more of the NIR sensors in the one row sensing a triggering amount of the emitted laser radiation reflecting off obstacles in front of the moving platform; and elevation circuitry to adjust the angle of elevation of the emitted laser radiation from among three or more angles of elevation at a time, including at least one angle of elevation corresponding to the surface level, at least one said angle of elevation corresponding to the platform level, and at least one said angle of elevation corresponding to the horizon level, the at least 100 rows including a corresponding three or more rows corresponding to the three of more angles of elevation.

Example 17 includes the lidar system of Example 16, further including size circuitry to estimate horizontal sizes of the obstacles from corresponding consecutive said stored clock signal values.

Example 18 includes the lidar system of Example 16, wherein the emitted laser radiation is eye-safe in that the laser radiation is at least 850 nanometers (nm) in wavelength, the laser radiation has a pulse duration of at least 1 nanosecond (ns), each pulse of the laser radiation does not exceed one microjoule (μJ) of light energy per square centimeter (cm²) of output aperture of the laser source, and consecutive pulses of the laser radiation are at least 500 microseconds (μs) apart.

Example 19 includes the lidar system of Example 16, wherein the horizontal fan-beam pattern is at least 90°, the azimuthal field of view is at least 90°, and consecutive said columns are no further than 11 milliradians (mrads) apart in azimuthal resolution at the angle of elevation.

Example 20 includes the lidar system of Example 16, wherein the elevation circuitry is further to adjust the angle of elevation to a different angle of elevation selected from a set of between three and ten angles of elevation, and to select each angle of elevation from the set of between three and ten angles of elevation, the at least 100 rows including a corresponding between three and ten rows corresponding to the between three and ten angles of elevation.

The terms and expressions which have been employed herein are used as terms of description and not of limitation, and there is no intention, in the use of such terms and expressions, of excluding any equivalents of the features shown and described (or portions thereof), and it is recognized that various modifications are possible within the scope of the claims. Accordingly, the claims are intended to cover all such equivalents. In addition, various features, aspects, and embodiments have been described herein. The features, aspects, and embodiments are susceptible to combination with one another as well as to variation and modification, as will be understood by those having skill in the art. The present disclosure should, therefore, be considered to encompass such combinations, variations, and modifications. It is intended that the scope of the present disclosure be limited not be this detailed description, but rather by the claims appended hereto. Future filed applications claiming priority to this application may claim the disclosed subject matter in a different manner, and may generally include any set of one or more elements as variously disclosed or otherwise demonstrated herein.

What is claimed is:

1. An obstacle sensing lidar system comprising:
a laser source to emit laser radiation in a horizontal fan-beam pattern of at least 60° at an angle of elevation in front of a moving platform;
a sensing device having an array including a row of 100 or more near-infrared (NIR) sensors to sense corresponding reflections of the emitted laser radiation off obstacles in front of the moving platform, each NIR sensor being a pixel in the array; and
elevation circuitry to adjust the angle of elevation of the emitted laser radiation to a first angle of elevation, a second angle of elevation greater than the first angle of elevation, and a third angle of elevation greater than the second angle of elevation.

2. The lidar system of claim 1, further comprising a processor to estimate horizontal sizes of the obstacles from corresponding consecutive said sensed reflections.

3. The lidar system of claim 1, wherein the emitted laser radiation is eye-safe in that
the laser radiation is at least 850 nanometers (nm) in wavelength,
the laser radiation has a pulse duration of at least 1 nanosecond (ns),
each pulse of the laser radiation does not exceed one microjoule (μJ) of light energy per square centimeter (cm²) of output aperture of the laser source, and
consecutive pulses of the laser radiation are at least 500 microseconds (μs) apart.

4. The lidar system of claim 1, wherein consecutive said NIR sensors are no further than 8 milliradians (mrads) apart in azimuthal resolution at the angle of elevation.

5. The lidar system of claim 1, wherein the row is a first row of NIR sensors, the sensing device further including a plurality of rows of NIR sensors including the first row, each row to sense the reflections at one or more angles of elevation, each angle of elevation corresponding to one or more of the rows of NIR sensors but not all the rows of NIR sensors.

6. The lidar system of claim 1, wherein the elevation circuitry is further to adjust the angle of elevation to a different angle of elevation selected from a set of between three and ten angles of elevation, and to select each angle of elevation from the set of between three and ten angles of elevation, the set of between three and ten angles of elevation including at least one angle of elevation corresponding to the surface level, at least one angle of elevation corresponding to the platform level, and at least one angle of elevation corresponding to the horizon level.

7. The lidar system of claim 6, wherein the set of between three and ten angles of elevation is a first set of between three and ten angles of elevation, the elevation circuitry being further to switch to a second set of between three and ten angles of elevation different than the first set.

8. The lidar system of claim 1, wherein the sensing device comprises a common clock signal, a value of the common clock signal being stored in response to one or more of the NIR sensors sensing a triggering amount of the emitted laser radiation reflecting off the obstacles.

9. The lidar system of claim 1, wherein the laser source is further to emit pulses of the laser radiation, the lidar system further comprising pulse circuitry to control the emitted pulses of the laser source.

10. A method of obstacle sensing using lidar, the method comprising:
emitting, by a laser source, eye-safe near-infrared (NIR) laser radiation in a horizontal fan-beam pattern of at least 60° at an angle of elevation in front of a moving platform;
sensing, by a row of NIR sensors, corresponding azimuthal reflections of the emitted laser radiation off obstacles for an azimuthal field of view of at least 60° at the angle of elevation in front of the moving platform, consecutive said NIR sensors being no further than 21 milliradians (mrads) apart in azimuthal resolution; and
adjusting, by elevation circuitry, the angle of elevation of the emitted laser radiation from among three or more angles of elevation at a time, including at least one angle of elevation corresponding to the surface level, at least one angle of elevation corresponding to the platform level, and at least one angle of elevation corresponding to the horizon level.

11. The method of claim 10, further comprising estimating, by size circuitry, horizontal sizes of the obstacles from corresponding consecutive said sensed azimuthal reflections.

12. The method of claim 10, wherein emitting the laser radiation is eye-safe in that emitting the laser radiation comprises emitting the laser radiation of at least 850 nanometers (nm) in wavelength with a pulse duration of at least 1 nanosecond (ns), each pulse of the laser radiation not exceeding one microjoule (μJ) of light energy per square centimeter (cm²) of output aperture of the laser source, and consecutive pulses of the laser radiation being at least 500 microseconds (μs) apart.

13. The method of claim 10, wherein the row of NIR sensors is a first row of a plurality of rows of NIR sensors, and sensing the azimuthal reflections comprises sensing, by a corresponding three or more of the rows of NIR sensors, corresponding azimuthal reflections of the emitted laser radiation off the obstacles at the three or more angles of elevation.

14. The method of claim 13, wherein
the plurality of rows comprises 100 or more rows,
adjusting the angle of elevation comprises adjusting the angle of elevation to a different angle of elevation selected from a set of between three and ten angles of elevation, and selecting each angle of elevation from the set of between three and ten angles of elevation, and
sensing the azimuthal reflections comprises sensing, by a corresponding between three and ten of the rows of NIR sensors, corresponding azimuthal reflections of the emitted laser radiation off the obstacles at the between three and ten angles of elevation.

15. The method of claim 10, wherein sensing the azimuthal reflections comprises storing a value of a common clock signal in response to one or more of the NIR sensors sensing a triggering amount of the emitted laser radiation reflecting off the obstacles.

16. An obstacle sensing lidar system comprising:
a laser source to emit eye-safe near-infrared (NIR) laser radiation in a horizontal fan-beam pattern of at least 60° at an angle of elevation in front of a moving platform;
a readout integrated circuit (ROIC) including
a common clock signal, and
an array of NIR sensors arranged in at least 100 rows by elevation sensed and including one row corresponding to the angle of elevation, and in at least 100 columns by azimuth sensed and spanning an azimuthal field of view of at least 60°, a value of the common clock signal being stored in response to one or more of the NIR sensors in the one row sensing a triggering amount of the emitted laser radiation reflecting off obstacles in front of the moving platform; and
elevation circuitry to adjust the angle of elevation of the emitted laser radiation from among three or more angles of elevation at a time, including at least one angle of elevation corresponding to the surface level, at least one said angle of elevation corresponding to the platform level, and at least one said angle of elevation corresponding to the horizon level, the at least 100 rows including a corresponding three or more rows corresponding to the three of more angles of elevation.

17. The lidar system of claim 16, further comprising size circuitry to estimate horizontal sizes of the obstacles from corresponding consecutive said stored clock signal values.

18. The lidar system of claim 16, wherein the emitted laser radiation is eye-safe in that
the laser radiation is at least 850 nanometers (nm) in wavelength,
the laser radiation has a pulse duration of at least 1 nanosecond (ns),
each pulse of the laser radiation does not exceed one microjoule (μJ) of light energy per square centimeter (cm²) of output aperture of the laser source, and
consecutive pulses of the laser radiation are at least 500 microseconds (μs) apart.

19. The lidar system of claim 16, wherein the horizontal fan-beam pattern is at least 90°, the azimuthal field of view is at least 90°, and consecutive said columns are no further than 11 milliradians (mrads) apart in azimuthal resolution at the angle of elevation.

20. The lidar system of claim 16, wherein the elevation circuitry is further to adjust the angle of elevation to a different angle of elevation selected from a set of between three and ten angles of elevation, and to select each angle of elevation from the set of between three and ten angles of elevation, the at least 100 rows including a corresponding between three and ten rows corresponding to the between three and ten angles of elevation.
